(19) United States
(12) Patent Application Publication
(10) Pub. No.: US 2024/0027748 A1
(43) Pub. Date: Jan. 25, 2024

(54) SCANNING PROJECTOR PERFORMING CONSECUTIVE NON-LINEAR SCAN WITH MULTI-RIDGE LIGHT SOURCES

(71) Applicant: Meta Platforms Technologies, LLC, Menlo Park, CA (US)

(72) Inventors: Daniel Guenther GREIF, Seattle, WA (US); Brian WHEELWRIGHT, Sammamish, WA (US); Jacques GOLLIER, Sammamish, WA (US)

(73) Assignee: Meta Platforms Technologies, LLC, Menlo Park, CA (US)

(21) Appl. No.: 17/872,943

(22) Filed: Jul. 25, 2022

(51) Int. Cl. G02B 26/10; G02B 26/08; G02B 27/01; F21V 8/00

(52) U.S. Cl. CPC G02B 26/101; G02B 26/0833; G02B 27/0172; G02B 6/0031; G02B 2027/0178

(57) ABSTRACT

A scanning projector of a near-eye display device may be coupled to a waveguide and include a multi-ridge light source to provide a light beam. A distance between ridges of the light source may be larger than one pixel and the ridges may be aligned horizontally, vertically, or at an angle. A two-dimensional (2D) beam scanner optically coupled to the light source may generate a light field by performing a biresonant scan of the light beam. The projector may also include or be coupled to a controller to cause the beam scanner to scan the light beam about a first axis and a second axis within a field of view following a coherent Lissajous pattern while varying a brightness of the light beam to provide the image.

### TECHNICAL FIELD

This patent application relates generally to visual display devices, and in particular to scanning projectors with multi-ridge light sources using coherent Lissajous painting.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices require compact and efficient components and modules such as light sources, image projectors, beam scanners, etc., that would have low image artifacts.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIGS. 3A and 3B illustrate a perspective view and a top view of a near-eye display in the form of a pair of glasses, according to an example.

FIG. 4A illustrates a schematic view of a near-eye display based on a scanning image projector, according to an example.

FIG. 4B illustrates a schematic view of a scanning image projector of the near-eye display of FIG. 4A, where the scanning image projector uses a 2D tiltable micro-electromechanical system (MEMS) reflector, according to an example.

FIG. 5 illustrates a trace diagram of a biresonant Lissajous scanning by the scanning projector display of FIG. 4A, according to an example.

FIGS. 6A-6C illustrate views of a nearly 2:1 Lissajous scanning trace at different phases of the Lissajous figure, according to an example.

FIG. 7A illustrates scans from a vertically aligned, 1-pixel separated, 6-emitter system over a multi-ridge light source chip, according to an example.

FIG. 7B illustrates scans from a horizontally aligned, 3-pixel separated, 6-emitter system over a multi-ridge light source chip, according to an example.

FIGS. 8A-8C illustrate different phases of full trajectory a trace diagram and four possible directions of a biresonant Lissajous scanning, according to an example.

FIGS. 9A-9C illustrate various design parameters on vertically, horizontally, and angled alignment scanning, according to an example.

FIG. 9D illustrates an oversized micro-electromechanical system (MEMS) scanning, where micro-electromechanical system (MEMS) field of view (FOV) may be larger than image painting field of view (FOV), according to an example.

FIG. 10 is a flow diagram illustrating an example method for coherent Lissajous painting with multi-ridge light sources, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Virtual reality (VR) and augmented reality (AR) displays may offer a significantly wider field of view (FOV) than traditional displays, creating an immersive experience for a user. A projector display may be used with an X- and Y-tiltable reflector, or a pair of unidirectionally tiltable reflectors, to scan an image-forming light beam across the display's field of view (FOV). Operating the tiltable reflector(s) near mechanical oscillation resonance(s) provides fast scanning rates with less energy consumption in comparison with raster-type scanning. Since a fast scanner consumes a considerable amount of energy, the biresonant scanning may be preferred as it allows considerable power savings.

Resonant scanning, however, may result in nonlinear scanning trajectories due to nearly-sinusoidal X- and Y-tilt angle variation of the tiltable reflector. These nonlinear trajectories may be approximated by a Lissajous pattern, which is a pattern produced by the intersection of two sinusoidal curves with axes at right angles or close to right angles to each other. A Lissajous pattern is an example of complex harmonic motion curves. While an entire image may be obtained by letting the Lissajous pattern to eventually cover the entire field of view of the display, artifacts may appear when a displayed image and/or the viewer's eyes are moving. The Lissajous biresonant scanning may cause splitting, shearing, banding, deformation, and even a complete breakdown of moving objects in the image beyond any recognition of the moving objects. Furthermore, the perceived imagery may be distorted, deformed, and/or appear structured even when the imagery remains still, and it is the viewer's eyes that are moving across the displayed imagery, following a displayed moving object, or performing a saccade-type movement, which may be distracting and unpleasant to the viewer.

In some examples of the present disclosure, a projector of a near-eye display may form an image in angular domain on an eye box for direct observation by a viewer's eye. The projector may employ a controllable light source (e.g., a laser source) and a micro-electromechanical system (MEMS) beam scanner to create a light field from, for example, a collimated light beam. The micro-electromechanical system (MEMS) beam scanner may paint the image on the eye box following a biresonant coherent Lissajous pattern. Emitters of a multi-ridge light source may be aligned horizontally, vertically, or at an arbitrary angle with more than one pixel ridge separation. As the field of view can have many different aspect ratios, the optimal angles may be in a range from 0 degrees to 180 degrees.

A coherent Lissajous scanning trajectory is a slowly evolving Lissajous pattern, where the lines evolve smoothly as time progresses. In a Lissajous pattern based scan, neighboring pixels on a same scanning line are painted almost instantaneously due to a high rate of nonlinear scanning, and the neighboring pixels of a different scanning line are painted with a small delay required for the scanned image light beam to finish the previous scanning line. It should be noted that the scanning line does not necessarily need to be horizontal or vertical. With a small delay, for example, when the image across at least 75% of an area of the field of view (FOV) is provided at the local rate of image painting of greater than 1500 degrees per second, the image scanning artifacts may be considerably reduced, or even completely eliminated. Herein, the term “local” refers to pixels on neighboring lines of the displayed image. Such scanning is termed herein “coherent” or “consecutive” scanning. The coherent nonlinear scanning enables reduction of motion-caused image artifacts despite the non-linear or resonant character of the scanning, that is, despite the scanning being absent a raster-type linear or a triangular scanning. At the same time, the resonant Lissajous scanning is considerably more energy-efficient than the raster-type linear or a triangular scanning.

In some examples, combining multi-ridge sources with Lissajous pattern painting may provide enhanced display resolution, refresh rate, and/or field of view (FOV). Whereas, employing a single-ridge source, display resolution, refresh rate, and/or field of view (FOV) may be limited.

In some examples, the coherent Lissajous pattern, which evolves temporally, may have a frequency ratio (movement along X- and Y-axes) M/N, where M and N are low integers that are mutually prime. In other examples, M and N may not necessarily be mutually prime. The projector may paint in one or more possible directions. A brush width of the projector may be selected greater than a skip (a separation between ridges) to avoid gaps in the image. Alternatively, the brush width may be smaller than the skip and any gaps may be mitigated by multi-directional painting or interlacing.

While some advantages and benefits of the present disclosure are apparent, other advantages and benefits may include reduction of motion-caused and stationary image artifacts through the use of a biresonant coherent Lissajous scanning. When scanning is performed within proposed parameter ranges and in certain directions, as disclosed herein, clearer and steadier images may be obtained approximating a linear raster-type scanning, while keeping the energy-saving advantages of biresonant scanning of a tiltable reflector as noted herein.

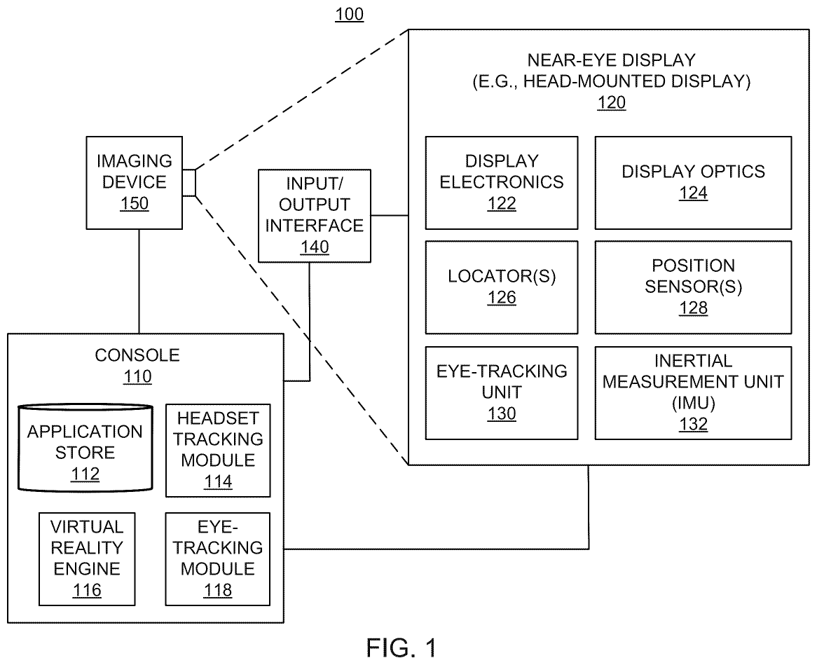

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

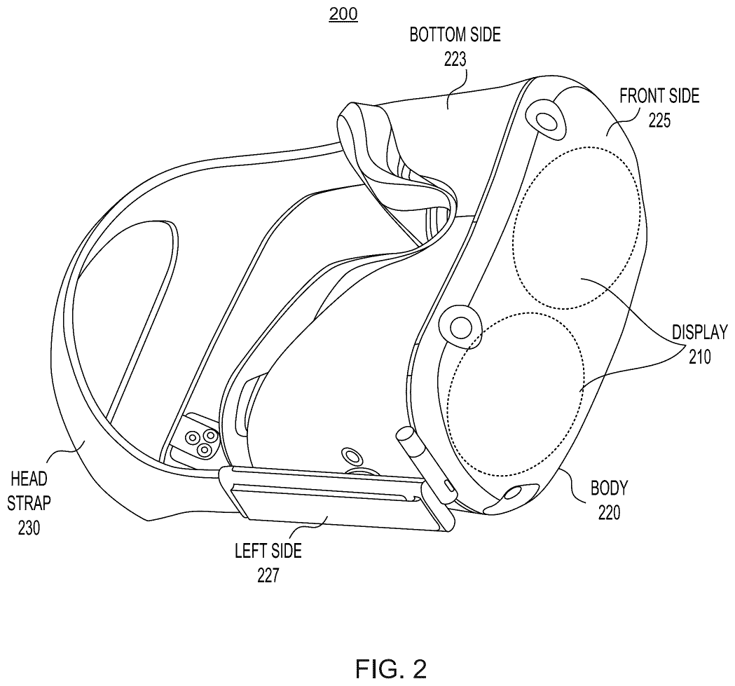

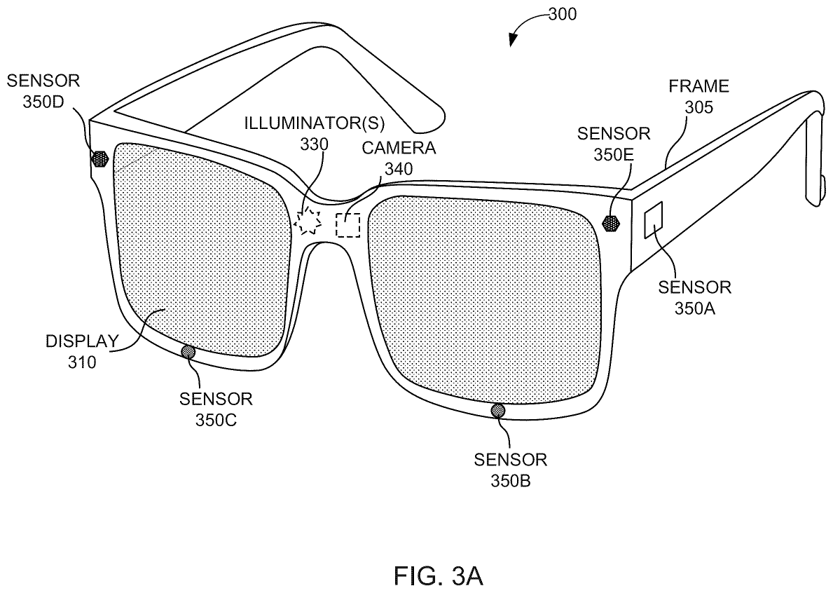

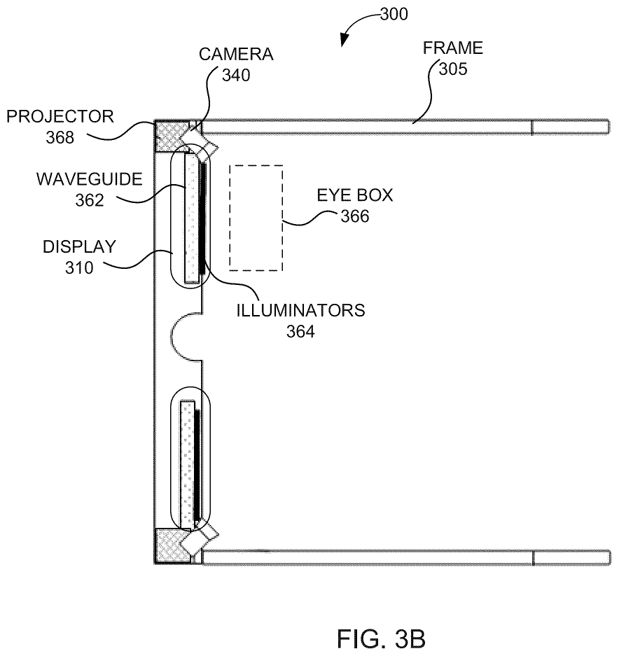

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye-tracking unit 130. In some examples, the near-eye display 120 may also include one or more locators 126, one or more position sensors 128, and an inertial measurement unit (IMU) 132. In some examples, the near-eye display 120 may omit any of the eye-tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. The micro-electromechanical system (MEMS) beam scanner may “paint” the image on an eye box following a biresonant coherent Lissajous pattern. Emitters of a multi-ridge light source may be aligned horizontally, vertically, or at an arbitrary angle with more than one pixel ridge separation.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye-tracking unit 130 may include one or more eye-tracking systems. As used herein, “eye tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye-tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye-tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye-tracking module 118. Based on the received information, the virtual reality engine 116 may determine content to provide to the near-eye display 120 for presentation to the user.

In some examples, the eye-tracking module 118 may receive eye-tracking data from the eye-tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye-tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the head-mounted device (HMD) device 200 may be a part of a virtual reality (VR) system, an augmented reality (AR) system, a mixed reality (MR) system, another system that uses displays or wearables, or any combination thereof. In some examples, the head-mounted display (HMD) device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components.

In some examples, the head-mounted display (HMD) device 200 may present, to a user, media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the head-mounted display (HMD) device 200.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface 140 for communicating with a console 110, as described with respect to FIG. 1. In some examples, the head-mounted display (HMD) device 200 may include a virtual reality engine (not shown), but similar to the virtual reality engine 116 described with respect to FIG. 1, that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine 116 may be used for producing a signal (e.g., display instructions) to the one or more display assemblies. In some examples, the head-mounted display (HMD) device 200 may include locators (not shown), but similar to the virtual locators 126 described in FIG. 1, which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, the projector may employ a controllable light source (e.g., a laser source) and a micro-electromechanical system (MEMS) beam scanner to create a light field from, for example, a collimated light beam. The micro-electromechanical system (MEMS) beam scanner may “paint” the image on an eye box following a biresonant coherent Lissajous pattern. Emitters of a multi-ridge light source may be aligned horizontally, vertically, or at an arbitrary angle with more than one pixel ridge separation.

FIG. 3A is a perspective view of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 210 may include a projector, or in place of the display 310 the near-eye display 300 may include a projector. The projector may form an image in angular domain for direct observation by a viewer's eye by painting the image on an eye box following a biresonant coherent Lissajous pattern.

In some examples, the near-eye display 300 may further include various sensors 350a, 350b, 350c, 350d, and 350e on or within a frame 305. In some examples, the various sensors 350a-350e may include any number of depth sensors, motion sensors, position sensors, inertial sensors, and/or ambient light sensors, as shown. In some examples, the various sensors 350a-350e may include any number of image sensors configured to generate image data representing different fields of views in one or more different directions. In some examples, the various sensors 350a-350e may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar application.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminator(s) 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications.

FIG. 3B is a top view of a near-eye display 300 in the form of a pair of glasses (or other similar eyewear), according to an example. In some examples, the near-eye display 300 may include a frame 305 having a form factor of a pair of eyeglasses. The frame 305 supports, for each eye: a scanning projector 368 such as any scanning projector variant considered herein, a pupil-replicating waveguide 362 optically coupled to the projector 368, an eye-tracking camera 340, and a plurality of illuminators 364. The illuminators 364 may be supported by the pupil-replicating waveguide 362 for illuminating an eye box 366. The projector 368 may provide a fan of light beams carrying an image in angular domain to be projected into a user's eye. The pupil-replicating waveguide 362 may receive the fan of light beams and provide multiple laterally offset parallel copies of each beam of the fan of light beams, thereby extending the projected image over the eye box 366. The coherence length of the laser sight source of the projector 368 may be less than a difference between optical path lengths of multiple light paths inside the pupil-replicating waveguide 362. This may allow reduction of optical interference at the eye box 366 between portions of the image light propagated via different light paths.

In some examples, multi-emitter laser sources may be used in the projector 368. Each emitter of the multi-emitter laser chip may be configured to emit image light at an emission wavelength of a same color channel. The emission wavelengths of different emitters of the same multi-emitter laser chip may occupy a spectral band having the spectral width of the laser source. The projector 368 may include, for example, two or more multi-emitter laser chips emitting light at wavelengths of a same color channel or different color channels. For augmented reality (AR) applications, the pupil-replicating waveguide 362 may be transparent or translucent to enable the user to view the outside world together with the images projected into each eye and superimposed with the outside world view. The images projected into each eye may include objects disposed with a simulated parallax, so as to appear immersed into the real-world view.

In some examples, instead of directly providing the light from multi-ridge sources (e.g., chips), light may be coupled from different chips or sources into photonic integrated circuit (PIC) waveguides (also referred to as “light channels”) or via fibers, thus providing a multi-emitter source with tight ridge spacing. Such light coupling may be used in example implementations as discussed herein.

The eye-tracking camera 340 may be used to determine position and/or orientation of both eyes of the user. Once the position and orientation of the user's eyes are known, a gaze convergence distance and direction may be determined. The imagery displayed by the projector 368 may be adjusted dynamically to account for the user's gaze, for a better fidelity of immersion of the user into the displayed augmented reality scenery, and/or to provide specific functions of interaction with the augmented reality. In operation, the illuminators 364 may illuminate the eyes at the corresponding eye boxes 366, to enable the eye-tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes 366.

In some examples, the image processing and eye position/orientation determination functions may be performed by a central controller, not shown, of the near-eye display 300. The central controller may also provide control signals to the projectors 368 to generate the images to be displayed to the user, depending on the determined eye positions, eye orientations, gaze directions, eyes vergence, etc.

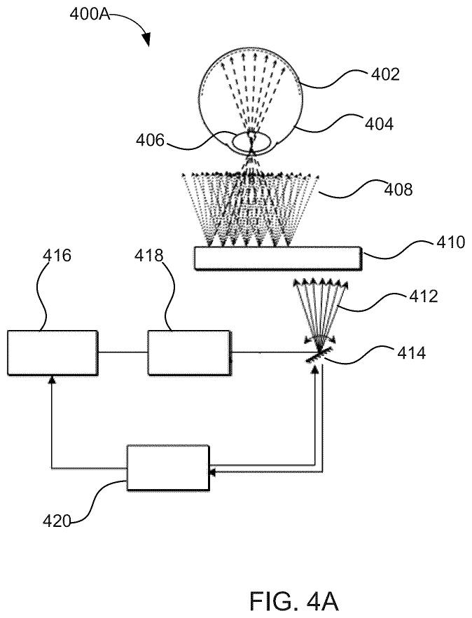

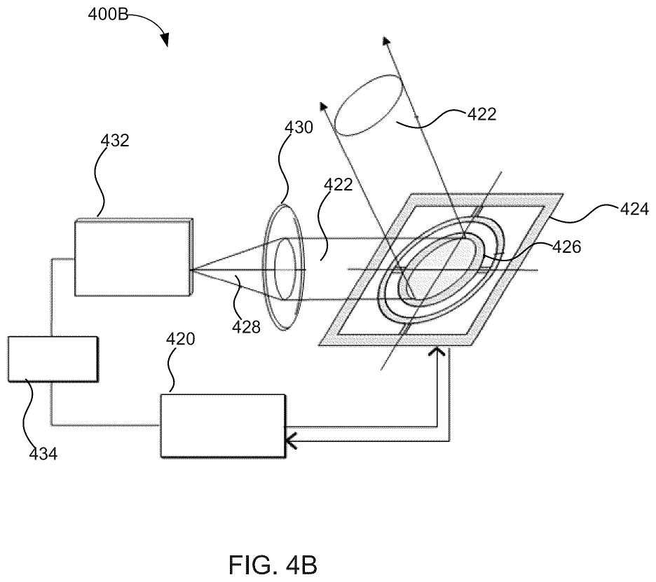

FIG. 4A illustrates a schematic view of a near-eye display based on a scanning image projector, according to an example. FIG. 4A shows a display device 400A including a light source 418, for example, a light-emitting diode or a laser diode, or another suitable semiconductor light source. The light source 418 may provide a light beam. An electronic driver 416 may be coupled to the light source 418 for powering the light source 418, for example, by providing a sequence of powering electric pulses. A beam scanner 414 including a tiltable reflector, for example, a micro-electromechanical system (MEMS) tiltable reflector described further below, may be optically coupled to the light source 418 for scanning the light beam generated by the light source 418. The scanning may be performed in one or two dimensions, for example, about an X-axis and/or Y-axis perpendicular to the X-axis, where X- and Y-axes are in plane of the micro-electromechanical system (MEMS) reflector at its normal (unpowered) position. A pupil replicator 410, for example, a pupil-replicating lightguide, may provide a light field 408 including multiple laterally shifted parallel portions of the scanned light beam 412. The multiple beam portions may have a same beam angle as a direction of propagation of the scanned light beam 412, at every moment of time as the light beam is scanned about one or two axes. While two-dimensional (2D) beam scanners are used as illustrative examples herein, implementations may also employ two one-dimensional (1D) beam scanners.

In some examples, a controller 420 may be coupled to the beam scanner 414 and the electronic driver 416 of the light source 418. The controller 420 may be configured to operate the electronic driver 416 to power the light source 418 in coordination with driving the beam scanner 414. For example, the controller 420 may apply a control signal to cause the beam scanner 414 to scan the light beam through a succession of beam angles or directions, while also applying a power signal to cause the electronic driver 416 to change the brightness of the light source 418 in accordance with an image to be displayed, thus forming an image in angular domain for direct observation by a viewer's eye 404 through a pupil 406. As used herein, the term “image in angular domain” means an image where different pixels of the displayed image are represented by angles of corresponding rays of image light, the rays carrying optical power levels and/or color composition corresponding to brightness and/or color values of the image pixels.

The pupil replicator 410 may provide multiple laterally displaced or laterally offset parallel portions or sub-beams of the scanned light beam 412 propagating in the same directions, as illustrated. The viewer's eye 404 may receive the light field 408 and form an image at the eye's retina 402 from the corresponding replicated sub-beams. A linear position of the beam portions on the eye's retina 402 may correspond to the beam angles or directions of the scanned light beam 408. In this manner, the eye 404 may form an image in linear domain on the eye's retina 402 from the image in the angular domain formed by the light field 408. It should be noted that in FIG. 1, the beam scanner 414 and the eye are on opposite sides of the pupil replicator 410. In some examples, a projector system may illuminate the pupil replicator 410 from the eye-side. The principles described herein may also apply to non-lightguide combiners. For example, the principles of this disclosure may apply to elliptical or holographic combiners.

FIG. 4B illustrates a schematic view of a scanning image projector of the near-eye display of FIG. 4A, where the scanning image projector uses a 2D tiltable micro-electromechanical system (MEMS) reflector, according to an example. A scanning projector 400B in FIG. 4B includes a light engine 432 coupled to a beam scanner 424. The light engine 432 may include a single emitter or an array of emitters for providing a diverging light beam 428 of different brightness, color composition, etc. A collimator 430 may optically coupled to the light engine 432, to collimate the diverging light beam 428 optionally and provide a collimated light beam 422, which is optically coupled to the beam scanner 424. The collimator 430 may be a lens or any other optical component having optical power, that is, focusing or collimating power, such as a concave mirror, a diffractive lens, a folded-beam freeform optical element, etc. The reflector 426 of the beam scanner 424 may be optically coupled to the collimator 430 for receiving and angularly scanning the collimated light beam 422 to form the image in angular domain.

In some examples, the controller 420 may be operably coupled to an electronic driver 434, which is coupled to the light engine 432. The controller 420 may be coupled to the beam scanner 424 for controllable tilting of the reflector 426 through 2D micro-electromechanical system (MEMS) scanning. The electronic driver 434 may be configured to provide powering electric signals to energize different emitters of the light engine 432.

In an example operation, the controller 420 may send commands to the electronic driver 434 to energize the light engine 432 in coordination with tilting the beam scanner 424, for providing, or “painting”, an image in angular domain. When viewed by a human eye, the image in angular domain is projected by the eye's cornea and lens to become a spatial-domain image on the eye's retina, as explained above. In some examples, the beam scanner 424 may be replaced with a pair of 1D tiltable mirrors, one for scanning about X-axis, and the other for scanning about Y-axis. The two 1D tiltable mirrors may be optically coupled via a pupil relay, for example. Other types of scanners may also be used. The light engine 432 may include single-mode or multimode emitters, for example and without limitation side-emitting laser diodes, vertical-cavity surface-emitting laser diodes, superluminescent light-emitting diodes, light-emitting diodes, etc.

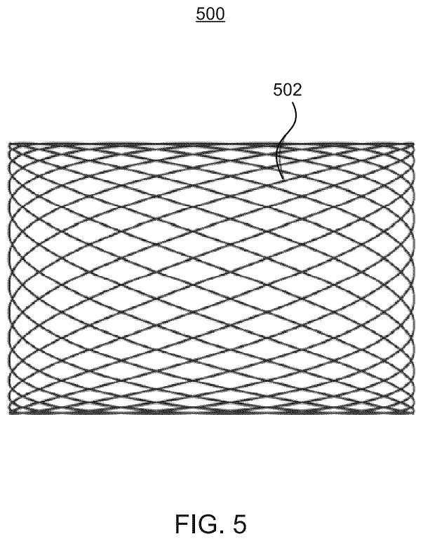

FIG. 5 illustrates a trace diagram 500 of a biresonant Lissajous scanning by the scanning projector display of FIG. 4A, according to an example. The trace diagram 500 shows a nonlinear trajectory 502 of the collimated light beam 422 in X- and Y-angles defined by the beam scanner 424 of the scanning projector 400B of FIG. 4B. In this example, the beam scanner 424 may operate in a biresonant mode, that is, the X- and Y-oscillations of the tiltable reflector 426 may be at or near corresponding mechanical oscillation resonances. At or near resonances, mechanical oscillations are substantially sinusoidal. Since the X- and Y-oscillations of the reflector 426 are substantially sinusoidal, the trajectory 502 is generally a complex Lissajous figure, or a combination of Lissajous figures that, after a sufficient number of oscillation periods, will cover the entire field of view of the image provided by the scanning projector 400B. When the Lissajous scanning is performed faster than a time response of a human eye, the eye will see a steady image.

When the order of “painting” of individual image pixels in the trace diagram 500 is pseudo-random, interlaced, and/or changes direction of painting the pixels of neighboring portions of the image being displayed, the eye and/or displayed object movement may result in image distortions, banding, or a complete image breakdown. In other words, the benefit of reduced power consumption due to (bi)resonant scanning of a tiltable reflector may come at a cost of introducing image motion artifacts.

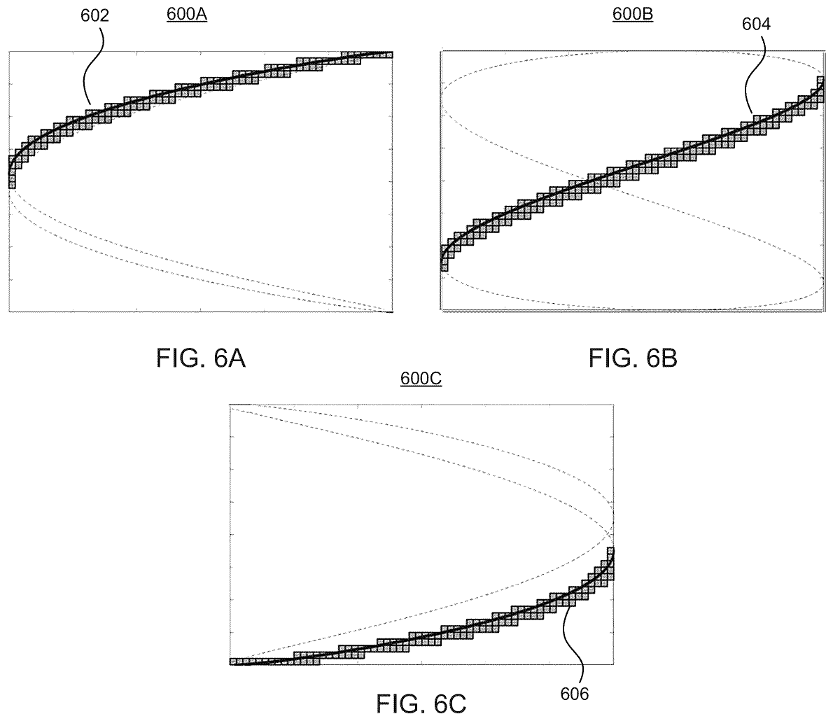

FIGS. 6A-6C illustrate views of a nearly 2:1 Lissajous scanning trace at different phases of the Lissajous pattern, according to an example. Diagrams 600A, 600B, and 6000 show painting of a field of view (FOV) along a biresonant Lissajous scanning trajectory at three distinct time points with illumination portions 602, 604, and 606, respectively. The trajectory over one period of the vertical scan and two periods of the horizontal scan is drawn with a thin dashed line. In this example, image painting is only performed over a fraction of the trajectory (e.g., illumination portions 602, 604, 606). Examples discussed herein are directed to coherent Lissajous painting. A coherent Lissajous scanning trajectory is a slowly evolving Lissajous pattern, where the illumination portions evolve smoothly as time progresses.

In some examples, the field of view (FOV) may be painted following the Lissajous scanning trajectory as the Lissajous pattern evolves temporally. The illumination portion 602 in diagram 600A shows the scanning trace as it is near a top of the field of view (FOV) at a beginning of a period (in Lissajous evolution). As the Lissajous pattern evolves the illumination portion may move downward in the field of view (FOV) as shown about a middle of the field of view (FOV) as illumination portion 604 in diagram 600B. The illumination portion 606 in diagram 6000 shows the illumination as the Lissajous evolution reaches an end of a period.

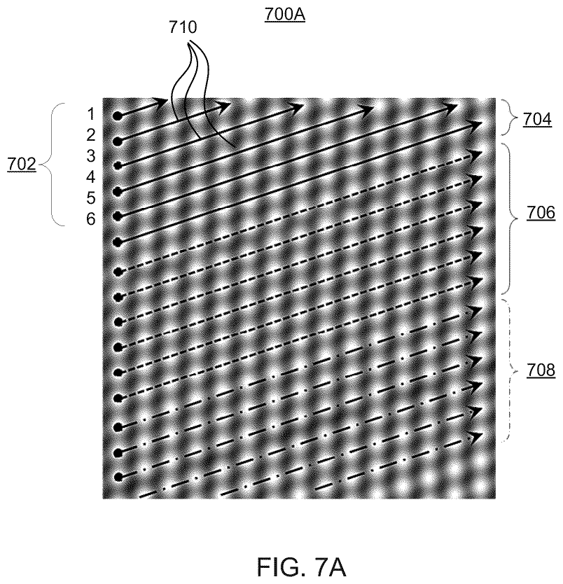

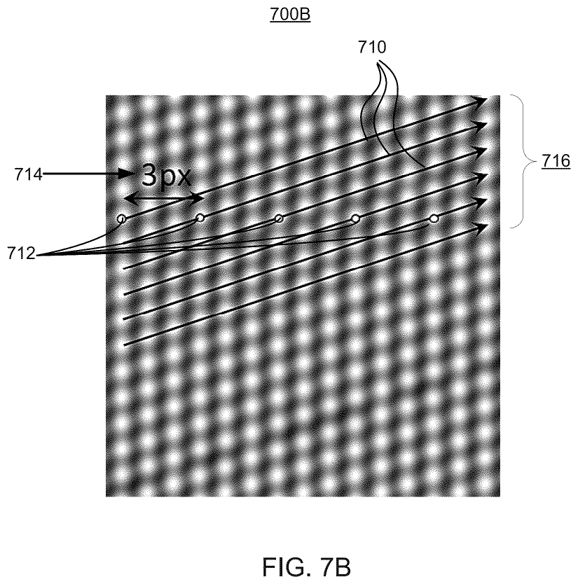

FIG. 7A illustrates scans from a vertically aligned, 1-pixel separated, 6-emitter system over a multi-ridge light source chip, according to an example. Diagram 700A shows six emitters (702) 1, 2, 3, 4, 5, and 6 that provide or “paint” pixels (circles with varying darkness) with each column of pixels being painted at different points in time. The firing of light pulses by a light engine may be synchronized with a scanning cycle of a micro-electromechanical system (MEMS) scanner about one or both axes, to ensure that the displayed pixels stay at a predictable grid of locations across the field of view (FOV).

The pixels of the displayed image, shown with circles of varying darkness, are painted by scanning an image light beam along scanning lines 710 running parallel to one another. Different scanning line groups (undashed, dashed in a first style, dashed in a second style) represent scans in a first period 704, a second period 706, and a third period 708 as the scan follows the Lissajous pattern. The emitters 702 may be a multi-ridge laser source. A ridge in a laser diode serves as a step-index waveguide ensuring that all of the light emitted from a p-n junction is contained and traveling in the designated direction. By adjusting a width of the ridge, various properties of the laser such as power, mode structure, and modulation speed (capacitance) may be controlled.

Coherent Lissajous painting over a substantial field of view (FOV) requires multiple emitters per color. Some painting schemes require one pixel ridge spacing. However, fabrication of multi-ridge chips with such small pitch may be challenging. Most fabrication techniques may have a limit of about 10 m. Conventional optical elements may be used to compensate, but may result in complex structures and loss of power due to pupil clipping. Use of a photonic integrated circuit (PIC) as a pitch converter may be an alternative, but integration and maintaining coupling efficiency may be challenging.

FIG. 7B illustrates scans from a horizontally aligned, 3-pixel separated, 6-emitter system over a multi-ridge light source chip, according to an example. Diagram 700B shows emitters 712 that paint pixels, where the ridges are aligned horizontally with larger than one pixel separation (e.g., three-pixel separation 714). Six scan lines are shown during a first period 716 of the Lissajous evolution (a sixth emitter is not shown). While example systems are shown with 6 emitters, other systems may be implemented with fewer or additional emitters using the principles described herein. A number of emitters may be in a range from 2 to 12, while practical implementations may employ 4 to 8 emitters.

In some examples, ridges may be aligned horizontally, vertically, or at an arbitrary angle with larger than single pixel spacing. In the example painting configuration of diagram 700B, a Lissajous pattern with 2:1 frequency ratio, a 60×40 field of view (FOV), and three-pixel ridge separation are used. An alternative example configuration may use 1:1 frequency ratio, 60×40 field of view (FOV) with 1.5-pixel separation. Embodiments are not limited to these example implementations, however. Furthermore, while six-ridge examples are shown herein, embodiments are not limited to a six-ridge configuration, any number of ridges may be aligned using the principles discussed herein.

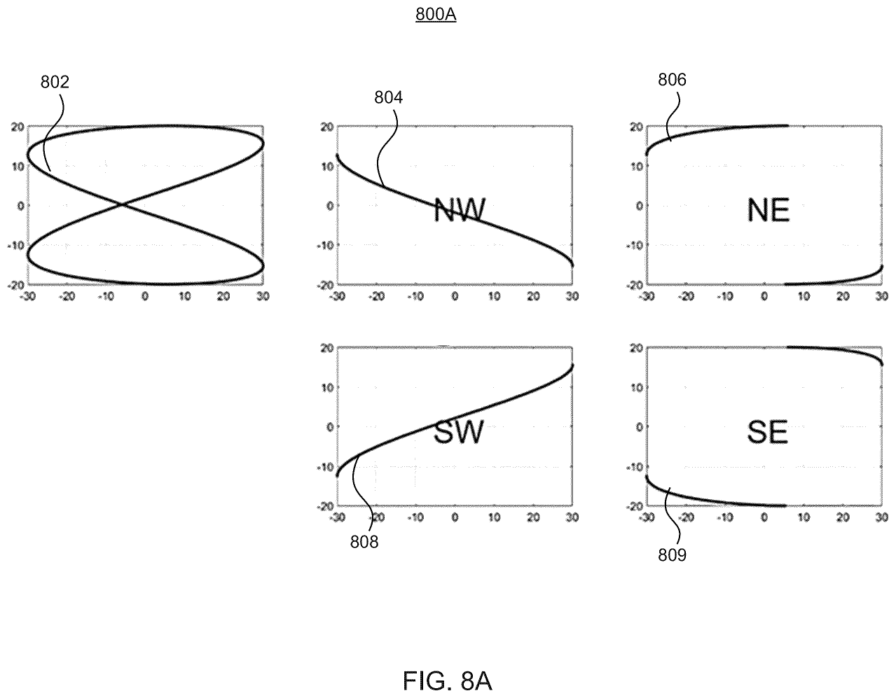

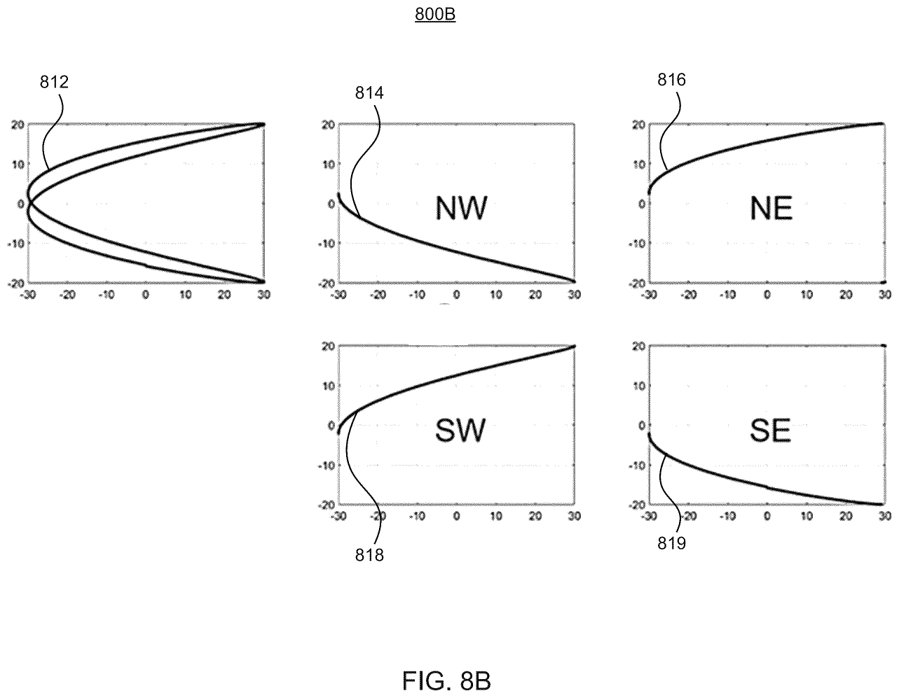

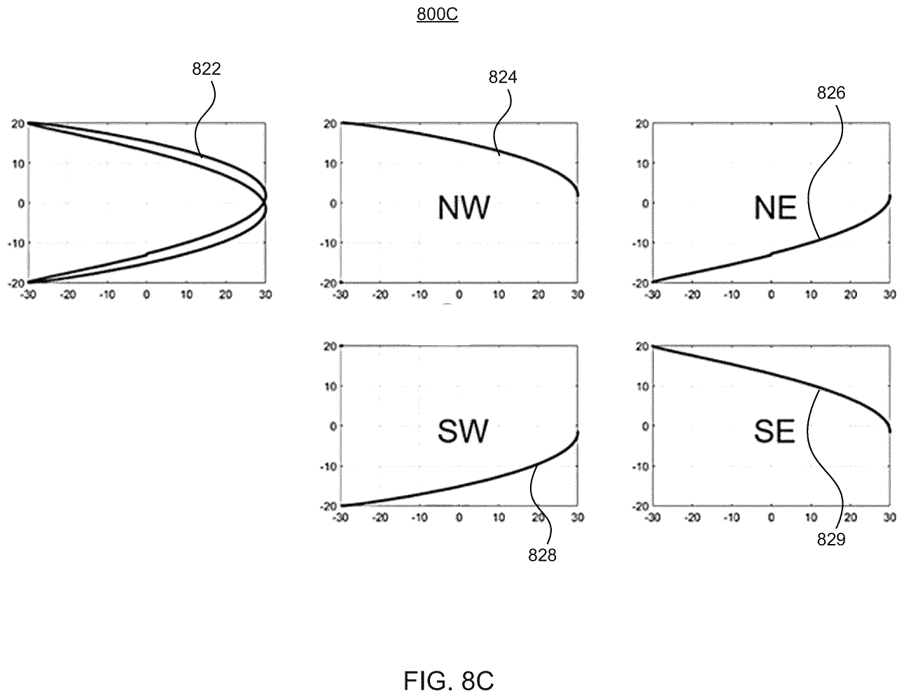

FIGS. 8A-8C illustrate different phases of full trajectory a trace diagram and four possible directions of a biresonant Lissajous scanning, according to an example. Diagrams 800A, 800B, and 8000 show Lissajous scanning traces 802, 812, 822 at different time points of its evolution. Trace portions 804, 806, 808, and 809 in diagram 800A represent the four possible painting directions (NW, NE, SW, and SE) for the Lissajous scanning trace 802 at the illustrated time point. Trace portions 814, 816, 818, and 819 in diagram 800B represent the four possible painting directions (NW, NE, SW, and SE) for the Lissajous scanning trace 812 at the illustrated time point. Trace portions 824, 826, 828, and 829 in diagram 8000 represent the four possible painting directions (NW, NE, SW, and SE) for the Lissajous scanning trace 822 at the illustrated time point.

In some examples, four possible painting directions may be available for the coherent Lissajous pattern. A sinusoidal curve has a positive and a negative slope value for intersection with X-axis and Y-axis at any given point. Thus, four different directions are available based on positive and negative X- and Y-velocities. Temporal dependencies of rotation angles of X- and Y-rotations of the rotation axes of the micro-electromechanical system (MEMS) may provide the trace portions shown in the diagrams. Any one of these possible painting directions may be used to paint a complete, artifact-free image. In order to increase refresh rate in certain regions of the field of view, multiple painting directions may be used simultaneously. For example, the image may be painted in both the NE and NW directions to increase refresh rate in the center of the field of view.

A Lissajous pattern has a substantially sinusoidal motion along X- and Y-axes with frequencies υₓ and υ_{y} and any phase difference(s). It should be noted, there may also be image distortion effects such pincushion, barrel, keystone shaped depending on a projector configuration. Thus, the expressions (1 and 2) below describing the Lissajous motion strictly refer to micro-electromechanical system (MEMS) X- and Y-rotation angles.

A coherent Lissajous pattern has a frequency ratio of υₓ/υ_{y}. The ratio may be close to 1:S, where S is a low integer, e.g., 1:1, 1:2, 1:3, etc. The integers in the ratio, M and N, may also be described as mutually prime. The Lissajous motion (based on time, t) along X- and Y-axes may be described as follows:

$$x ( t ) = \frac{{H}_{FOV}}{2} sin ( 2 π {v}_{x} t ) \qquad ( 1 )$$

$$y ( t ) = \frac{{V}_{FOV}}{2} sin ( 2 π \frac{M}{N} {v}_{x} t ) \qquad ( 2 )$$

where H_{FOV} and V_{FOV} may represent horizontal and vertical dimensions of the field of view (FOV), υₓ may represent the X-axis frequency, and M and N may represent mutually prime small integers such as 1, 2, 3. The example traces in diagrams 800A, 800B, and 8000 are for a Lissajous pattern with 1:2 frequency ratio.

In some examples, a laser or non-laser light source may be used in the projection and include side-emitting laser diodes, vertical-cavity surface-emitting laser diodes, superluminescent light-emitting diodes, light-emitting diodes, and similar ones. The pulsed light source may provide “firing opportunities” that may or may not be equidistant in time (periodic or aperiodic).

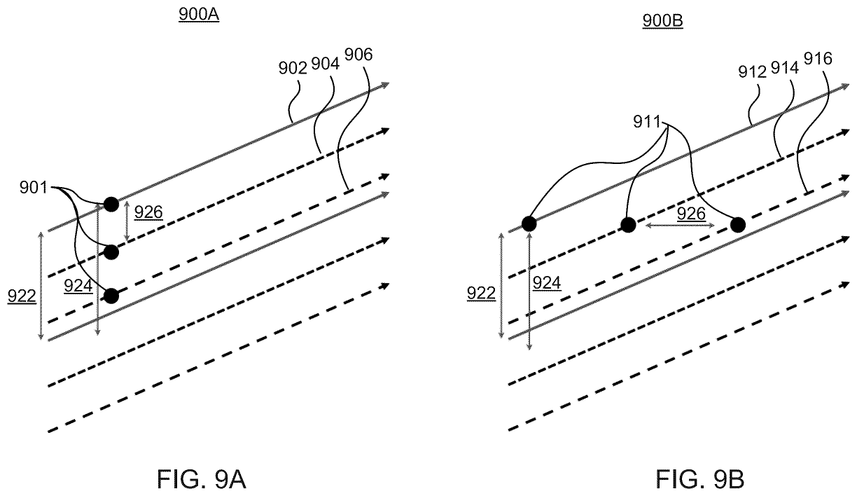

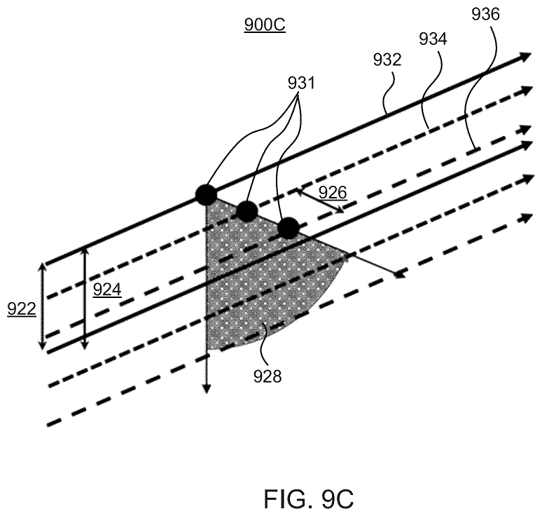

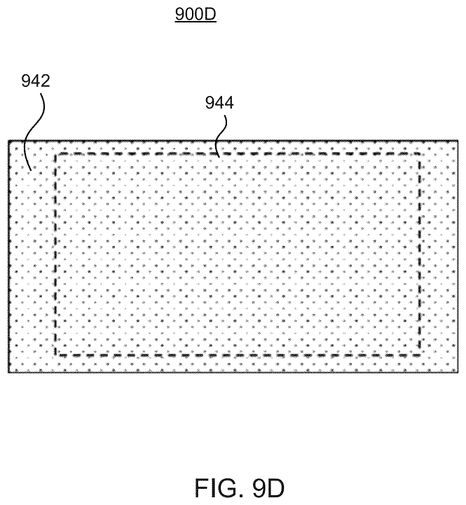

FIGS. 9A-9C illustrate various design parameters on vertically, horizontally, and angled alignment scanning, according to an example. Diagram 900A in FIG. 9A shows scanning lines 902, 904, and 906 painting the image from vertically aligned emitters 901. Different dashed (or undashed) lines represent scanning lines for different color emitters (e.g., green, blue, red). The diagram also shows a skip 922, a ridge pitch 926 (d), and a brush width 924.

In some examples, painting may be on full or part of the field of view (FOV). An actual image painting may happen on a subsection of the actual available frustum that is being swept by the micro-electromechanical system (MEMS) scanner. An example system may include more than one ridge per color with equidistant or non-equidistant angular spacing. In practical implementations, an upper limit for the number of ridges may be about 20 per color, for example. As discussed herein, painting may be in one of four directions. To avoid gaps, painting in multiple directions may also be employed. In practical implementations, one direction may be selected because it may resemble raster scanning and may provide perceptual advantage.

The skip 922 is the vertical displacement (for vertically aligned ridges) after S numbers of horizontal periods at the center of the field of view (FOV). A value of skip may be described as follows:

$$skip = \frac{{FOV}_{Y}}{2} sin ( S \times 2 π \frac{{v}_{Y}}{{v}_{X}} ) \qquad ( 3 )$$

where FOV_{Y} may represent a Y-axis dimension of the field of view (FOV), S may represent the number of horizontal periods, and υₓ and υ_{y} may represent the X-axis and Y-axis (horizontal and vertical) frequencies. In general, the skip 922 may vary across the field of view (FOV). In some sections of the field of view (FOV), there may be gaps. In other sections, there may be an overlap (e.g., peripheral areas).

In some examples, the skip 922 indicates how smoothly the Lissajous pattern is evolving (phase evolutions of the horizontal motion by an integer amount). A ridge pitch 926 (d) may be the distance between two ridges (and therefore two scanning lines). While an example value for the ridge pitch 926 may be selected as one-pixel, other values may also be used. For example, the ridge pitch may be selected using the following expression:

$$d = \frac{skip}{number of ridges} \qquad ( 4 )$$

The ridge pitch may also be selected differently for different colors. Yet, in other examples, the ridge pitch for different ridges (same color) may be different, thus the ridges may be non-equidistant.

In some examples, a brush width 924 may be selected wider than or equal to the skip 922 to avoid gaps. The brush width 924 may be described using following expression:

brush width=d*number of ridges (5)

For practical implementations, the brush width may be set equal to the skip at the center of the field of view (FOV). In other examples, the brush width may be selected smaller than the skip, which may result in gaps. However, the gaps may be mitigated by painting in more than one direction or multiple passes with a small shift (interlacing).

Diagram 900B in FIG. 9B shows scanning lines 912, 914, and 916 painting the image from horizontally aligned emitters 911. Different dashed (or undashed) lines represent scanning lines for different color emitters (e.g., green, blue, red). The diagram also shows a skip 922, a ridge pitch 926 (d), and a brush width 924. As in the example system of FIG. 9A, a horizontally aligned projector light source may include more than one ridge per color with equidistant or non-equidistant angular spacing. The painting may be in one or more of four directions.

The skip 922 for horizontal alignment is also the vertical displacement (for horizontally aligned ridges) after S numbers of horizontal periods at the center of the field of view (FOV). A value of skip for horizontal alignment may be described by the same expression as (3).

A ridge pitch 926 (d) for horizontal alignment may be the horizontal distance between two horizontally aligned ridges. The ridge pitch may be selected using the following expression:

$$d = pixel size \frac{{FOV}_{X}}{{FOV}_{Y}} \frac{{v}_{X}}{{v}_{Y}} \qquad ( 6 )$$

While an example value for the horizontal alignment ridge pitch 926 may be selected to ensure an equivalent vertical pitch of one-pixel, other values may also be used. The ridge pitch may also be selected differently for different colors. Yet, in other examples, the ridge pitch for different ridges (same color) may be different, thus the ridges may be non-equidistant.

In some examples, a brush width 924 may be selected wider than or equal to the skip 922 for horizontal ridge alignment to avoid gaps. The brush width 924 for horizontal alignment may be described using following expression:

$$brush width = \frac{{FOV}_{X}}{{FOV}_{Y}} \frac{{v}_{X}}{{v}_{Y}} * d * number of ridges \qquad ( 7 )$$

For practical implementations, the brush width may be set equal to the skip at the center of the field of view (FOV). In other examples, the brush width may be selected smaller than the skip, which may result in gaps. However, the gaps may be mitigated by painting in more than one direction or multiple passes with a small shift (interlacing).

Diagram 9000 in FIG. 9C shows scanning lines 932, 934, and 936 painting the image from angled emitters 931 (at an angle α 928). Different dashed (or undashed) lines represent scanning lines for different color emitters (e.g., green, blue, red). The diagram also shows a skip 922, a ridge pitch 926 (d), and a brush width 924 for angled alignment. As in the example systems of FIGS. 9A and 9B, an angled alignment projector light source may include more than one ridge per color with equidistant or non-equidistant angular spacing. The painting may be in one or more of four directions. Diagram 9000 illustrates and example configuration where the painting direction is NE.

The skip 922 for angled alignment is also the vertical displacement after S numbers of horizontal periods at the center of the field of view (FOV). A value of skip for horizontal alignment may be described by the same expression as (3).

A ridge pitch 926 (d) for angled alignment may be the distance between two angled ridges. The ridge pitch may be selected using the following expression:

$${d}_{ridge} ( α ) = \frac{pixel size}{cos ( α ) - sin ( α ) \frac{{FOV}_{X} {v}_{X}}{{FOV}_{Y} {v}_{Y}}} \qquad ( 8 )$$

where α may represent the ridge angle. Negative α values may mean counter-clockwise angle. While an example value for the angled alignment ridge pitch 926 may be selected to ensure an equivalent vertical pitch of one-pixel, other values may also be used. The ridge pitch may also be selected differently for different colors. Yet, in other examples, the ridge pitch for different ridges (same color) may be different, thus the ridges may be non-equidistant.

In some examples, a brush width 924 may be selected wider than or equal to the skip 922 for horizontal ridge alignment to avoid gaps. The brush width 924 for horizontal alignment may be described using following expression:

$$brush width = [ cos ( α ) - sin ( α ) \frac{{FOV}_{X}}{{FOY}_{Y}} \frac{{v}_{X}}{{v}_{Y}} ] * d * number of ridges \qquad ( 9 )$$

For practical implementations, the brush width may be set equal to the skip at the center of the field of view (FOV). In other examples, the brush width may be selected smaller than the skip, which may result in gaps. However, the gaps may be mitigated by painting in more than one direction or multiple passes with a small shift (interlacing).

FIG. 9D illustrates an oversized micro-electromechanical system (MEMS) scanning, where micro-electromechanical system (MEMS) field of view (FOV) may be larger than image painting field of view (FOV), according to an example. Diagram 900D shows a micro-electromechanical system (MEMS) field of view (FOV) 942 overlaid with an image painting field of view (FOV) 944.

In some examples, painting may be on full or part of the field of view (FOV). An actual image painting may happen on a subsection of the actual available frustum that is being painted by the micro-electromechanical system (MEMS) scanner. In the example illustration, the micro-electromechanical system (MEMS) field of view (FOV) 942 may be 70 degrees wide (angle of scanned light beam from beam scanner), whereas the image painting field of view (FOV) 944 may be 60 degrees wide.

As mentioned herein, the brush width may be preferred to be greater than or equal to skip to avoid gaps. The oversized micro-electromechanical system (MEMS) painting in diagram 900D shows brush width greater than skip. Thus, all pixels are covered. In case of smaller brush width interlacing (multiple passes with small shift) or painting in two or more directions may be used to reduce or eliminate the gaps. In some examples, if the brush is too thin, the painting in local regions may not be exactly one-directional. A small gap may be left behind, which may be filled in on a subsequent pass or by a different painting direction. Thus, “75%” or a similar portion of the image area may be painted in one direction at a certain average velocity, while edges of the field of view (FOV) may be subjected to multi-directional and/or multiple sweeps.

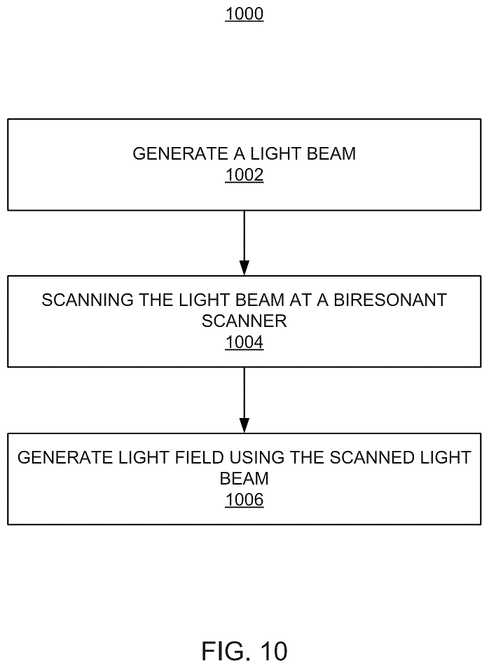

FIG. 10 is a flow diagram illustrating an example method 1000 for coherent Lissajous painting with multi-ridge light sources, according to some examples. The method 1000 is provided by way of example, as there may be a variety of ways to carry out the method described herein. Although the method 1000 is primarily described as being performed by the components of FIGS. 4A and 4B, the method 1000 may be executed or otherwise performed by one or more processing components of another system or a combination of systems. Each block shown in FIG. 10 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 1002, a light beam may be generated by a multi-ridge light source (light engine 432) of a scanning projector 424. A distance between ridges of the light source may be larger than one pixel and the ridges may be aligned horizontally, vertically, or at an angle.

At block 1004, the light beam may be scanned by a two-dimensional (2D) beam scanner about a first axis and a second axis within a field of view (FOV) following a coherent Lissajous pattern while varying a brightness of the light beam. The light beam may be scanned in at least one of four directions.

At block 1006, a light field 408 may be generated by a waveguide 362 (using the scanned light beam 412) on an eye box 366 to provide an image to a viewer through the eye box. In some examples, a brush width of the scanner may be selected to be greater than a skip. In other examples, the brush width may be selected to be smaller than the skip. As discussed herein, the skip is a vertical displacement for the ridges and is determined based on a vertical dimension of the field of view (FOV), a frequency ratio of the Lissajous pattern, and a number of horizontal periods of the Lissajous pattern. If the brush width is smaller than the skip, gaps may be formed in the image. To mitigate the gaps, multiple directions or interlacing may be used.

According to examples, a method of making a biresonant coherent Lissajous scanning based projector system with multi-ridge light source is described herein. A system of making the biresonant coherent Lissajous scanning based projector system with multi-ridge light source is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An apparatus, comprising:
a light source to provide a light beam;
a two-dimensional (2D) beam scanner optically coupled to the light source to receive the light beam and to generate a light field by performing a biresonant scan of the light beam; and
a controller communicatively coupled to the light source and the beam scanner, the controller to cause the beam scanner to scan the light beam about a first axis and a second axis within a field of view (FOV) following a consecutive non-linear pattern.

2. The apparatus of claim 1, wherein the consecutive non-linear pattern is a coherent Lissajous pattern.

3. The apparatus of claim 2, wherein the light source is a multi-ridge light source, and ridges of the multi-ridge light source are aligned horizontally, vertically, or at an angle.

4. The apparatus of claim 3, wherein a skip is a vertical displacement for the ridges of the multi-ridge light source and is determined by:
$$skip = \frac{{FOV}_{Y}}{2} sin ( S \times 2 π \frac{{v}_{Y}}{{v}_{X}} ) ,$$
where FOV_{Y} is a vertical dimension of a field of view (FOV), υₓ is a horizontal frequency of the Lissajous pattern, υ_{y} is a vertical frequency of the Lissajous pattern, and S is a number of horizontal periods of the Lissajous pattern.

5. The apparatus of claim 4, wherein a distance between two ridges is selected by a ratio of the skip over a number of ridges.

6. The apparatus of claim 4, wherein a brush width is selected to be equal or greater than the skip.

7. The apparatus of claim 4, wherein
a brush width is selected to be smaller than the skip, and
the controller is further to cause the beam scanner to scan the light beam in two or more directions.

8. The apparatus of claim 1, wherein the two-dimensional (2D) beam scanner comprises two one-dimensional (1D) scanners.

9. The apparatus of claim 1, wherein
the Lissajous pattern has a frequency ratio of M/N, where M and N are mutually prime integers, and
the controller is further to cause the beam scanner to scan the light beam in one of four painting directions.

10. The apparatus of claim 1, wherein the light source comprises one of a side-emitting laser diode, a vertical-cavity surface-emitting laser diode, a superluminescent light-emitting diode, or a light-emitting diode.

11. The apparatus of claim 1, wherein the beam scanner is a micro-electromechanical system (MEMS) scanner, and the beam scanner is to paint a field of view (FOV) that is larger than a field of view (FOV) of the provided image.

12. A near-eye display device, comprising:
a waveguide to provide an image on an eye box;
a projector optically coupled to the waveguide, the projector comprising:
a multi-ridge light source to provide a light beam, wherein a distance between ridges of the multi-ridge light source is larger than one pixel and the ridges are aligned horizontally, vertically, or at an angle;
a two-dimensional (2D) beam scanner optically coupled to the multi-ridge light source to receive the light beam and to generate a light field by performing a biresonant scan of the light beam; and
a controller communicatively coupled to the multi-ridge light source and the beam scanner, the controller to cause the beam scanner to scan the light beam about a first axis and a second axis within a field of view (FOV) following a coherent Lissajous pattern while varying a brightness of the light beam to provide the image.

13. The near-eye display device of claim 12, wherein
a skip is a vertical displacement for the ridges and is determined based on a vertical dimension of the field of view (FOV), a frequency ratio of the Lissajous pattern, and a number of horizontal periods of the Lissajous pattern, and
a distance between two ridges is selected by a ratio of the skip over a number of ridges.

14. The near-eye display device of claim 12, wherein
a brush width is selected to be equal or greater than the skip, or
the brush width is selected to be smaller than the skip, and the controller is further to cause the beam scanner to scan the light beam in two or more directions.

15. The near-eye display device of claim 12, wherein the Lissajous pattern has a frequency ratio of M/N, where M and N are mutually prime integers.

16. The near-eye display device of claim 11, wherein the multi-ridge light source comprises two or more ridges for each color, and the two or more ridges have equidistant angular spacing.

17. A method, comprising:
generating a light beam at a multi-ridge light source of a scanning projector, wherein a distance between ridges of the multi-ridge light source is larger than one pixel and the ridges are aligned horizontally, vertically, or at an angle,
scanning the light beam, at a two-dimensional (2D) beam scanner, about a first axis and a second axis within a field of view (FOV) following a coherent Lissajous pattern while varying a brightness of the light beam; and
generating a light field on an eye box, by a waveguide, to provide an image to a viewer through the eye box.

18. The method of claim 17, further comprising:
scanning the light beam in at least one of four directions.

19. The method of claim 17, further comprising:
selecting a brush width to be smaller than a skip, wherein the skip is a vertical displacement for the ridges and is determined based on a vertical dimension of the field of view (FOV), a frequency ratio of the Lissajous pattern, and a number of horizontal periods of the Lissajous pattern.

20. The method of claim 17, wherein the beam scanner is a micro-electromechanical system (MEMS) scanner, and the method further comprises:
painting a beam scanner field of view (FOV) that is larger than the field of view (FOV) of the provided image.
